(19) United States
(12) Patent Application Publication
(10) Pub. No.: US 2025/0053707 A1
(43) Pub. Date: Feb. 13, 2025

(54) DETERMINING A GEOMETRIC BOUNDARY FOR A MASS FLOW, FOR AN ENERGY FLOW, OR FOR A FORCE FLOW THROUGH A CHANNEL HAVING A CHANNEL WALL

(71) Applicant: Carl Zeiss GOM Metrology GmbH, Braunschweig (DE)

(72) Inventors: Jens Scharfenstein, Groß Flöthe (DE); Marc Landgraf, Hannover (DE); Theodor Möller, Braunschweig (DE)

(21) Appl. No.: 18/929,492

(22) Filed: Oct. 28, 2024

Related U.S. Application Data
(63) Continuation of application No. PCT/EP2023/061040, filed on Apr. 26, 2023.

(30) Foreign Application Priority Data
Apr. 28, 2022 (DE) 10 2022 204 190.9

(51) Int. Cl. G06F 30/23; G06F 30/10; G06F 113/08

(52) U.S. Cl. CPC G06F 30/23; G06F 30/10; G06F 2113/08

(57) ABSTRACT

A computer-implemented method for determining a geometric boundary for a mass flow, an energy flow, or a force flow through a channel having a channel wall includes receiving coordinates of edge points of an edge line of a cross-sectional face of the channel, receiving or producing with the edge points, a cross-sectional tiled face with a gap-free and overlap-free arrangement of polygonal flat tiles, the edge points being vertices of tiles of the tiled face, and the edge points and all additional, inner vertices of the tiles, determining additional cross-sectional tiled faces by iteration, varying in the iteration the location of both edge points and inner vertices, terminating the iteration when a predefined termination criterion is met, and outputting information about a smallest cross-sectional face for which, with respect to the tiled faces of the iteration, the total area of all tiles of the tiled face in question is minimized.

### CROSS REFERENCE TO RELATED APPLICATIONS

This application is a continuation application of international patent application PCT/EP2023/061040, filed Apr. 26, 2023, designating the United States and claiming priority to German application 10 2022 204 190.9, filed Apr. 28, 2022, and the entire contents of these applications are incorporated herein by reference.

### TECHNICAL FIELD

The disclosure relates to a computer-implemented method for determining a geometric boundary for a mass flow, for an energy flow, or for a flow of force through a channel having a channel wall. The disclosure also relates to a corresponding apparatus for data processing.

In particular, the disclosure relates to mass flows such as gas and/or liquid flows and such as material-bound flows (e.g., electric currents), but also to flows of force as occur in the transfer of torques by a shaft, for example. In any case, an outer channel wall is present, beyond which there is no mass flow, energy flow, or flow of force. As a rule, there is no flow in the channel wall in the case of gas flows and/or liquid flows. The channel wall, which is generally made of solid matter, bounds the space of the channel available to the flow. By contrast, the current or the flux in the case of flows of charge carriers (which can be considered an energy flow and also a mass flow) in electrically conductive materials and also in the case of a flow of force occurs throughout the matter. In that case, the channel is not a space free from solid matter, which is bounded by the sleeve, but a space filled with generally solid matter. This does not preclude the case that, in addition to that or in an alternative, gaseous matter is the carrier of the flow, especially in the case of an electric current. To transfer force or transfer moments, a channel is generally formed solid out of a solid material, with the result that the channel wall is only defined by the surface or surface layer of the material. This does not preclude the fact that channels for force transfer or moment transfer have cavities. In all cases, the channel wall can be considered to be an outer sleeve or, in some cases, an inner sleeve of the channel.

### BACKGROUND

What is common to flows of force and mass flows is that a vector field which, in relation to the local region of the channel, describes the flow or flux in respect of its strength and direction can be specified at any time. In the case of a mass flow, this is the vector field of the velocities of the flowing mass, for example. Other vector fields which describe the flow of a scalar physical parameter through a channel or the flux corresponding to a vectorial physical parameter and corresponding to the boundaries of a channel-shaped region (for example, in the case of the aforementioned shaft for transferring torques) are also conceivable.

The disclosure is also applicable to such other fluxes or flows.

For example, as specified on the Internet at the URL https://systemdesign.ch/wiki/Kraftfluss (retrieved on Apr. 4, 2022), a flow of force can be defined as “path of a force and/or a moment in a component from the point of attack (location of the introduction) to the location at which said force and/or moment is/are absorbed by a reaction force and/or a reaction moment.” Further, the following description of the term “flow of force” from another source is cited: “When developing true-to-scale designs, the designer is often confronted by the problem of having to ensure an optimal conduction of forces, torques and/or bending moments by the envisaged function carriers. To illustrate the function of guiding forces and moments, use of the term flow of force is popular.” Corresponding definitions can also be provided for other fluxes of a vectorial physical parameter.

Thus, there is no mass flow or energy flow in a flow of force. Nevertheless, a physical parameter is conducted through a channel on a path or, corresponding to the underlying vector field, on a plurality of parallel paths. In this respect, the physical description is similar to that of a water flow through a channel.

It follows from the aforementioned citation with respect to a flow of force that, for application in the respective technical field, a person skilled in the relevant art must have knowledge of the geometry of the channel or, when constructing a channel, must have information about the effect of the flow of force on account of the geometry. Corresponding statements apply to a mass flow or energy flow. For example, when constructing turbomachines such as gas turbines, for example, there are attempts to quickly render fluid-mechanical effects and parameters measurable by way of correlations with geometric parameters. Simulations of the flows are computationally intensive and hence protracted. In this case, the position, shape and size of the smallest cross-sectional area of the channel or a channel section is used as geometric parameter. In the case of an electric current and in the case of a flow of force, it is self-evident that not only the geometry of the channel but also the transfer properties of the electrically conductive or force-transferring material need to be taken into account. In the case of a gas and/or liquid flow, too, further influencing factors are important for the description of the flow or for the construction of the channel, specifically the interaction of the mass flow with the channel wall.

As already mentioned, a substantial influencing parameter for the description of the aforementioned fluxes and flows is the smallest cross-sectional area through which the flux or flow passes within the channel or at the end of the channel. The smallest cross-sectional area of the channel contributes significantly to the resistance to the flux or flow or to the bounding of the flux or the flow. Expressed differently, in view of the smallest cross-sectional area, in many cases it cannot be expected that the realizable flux or flow through the channel exceeds a maximum value corresponding to the smallest cross-sectional area. Thus, the smallest cross-sectional area represents a geometric boundary for the mass flow, energy flow or for the flow of force through the channel. Further, especially in the case of gas and/or liquid flows, the smallest cross-sectional area can be essential information with regards to the type of flow, for example laminar or, at least locally, turbulent flow. The smallest cross-sectional area can also be referred to as “narrowest cross section” (or “throat area”).

Should the channel extend in a straight line and have a constant cross section over its profile, the specification of the smallest cross-sectional area is trivial and can be calculated from any contour along the channel. The channel is frequently only bounded by an outer channel wall. However, the channel is not precluded from also having an inner channel wall; for example, this occurs in practice in the case of pipes running within a channel. The calculation of the minimal cross-sectional area can also be easy in a few other cases besides straight-line channels with a constant cross section. However, the calculation of the minimal cross-sectional area can already be non-trivial for pipe elbows, for example, which have a special shape at their end in order to create a tight connection to a further pipe piece.

Examples of channels to which the method according to an aspect of the disclosure can be applied, especially with the aid of the apparatus according to an aspect of the disclosure, are channels between two blades of a blade ring in a turbomachine, for example a gas turbine, an aircraft engine or an axial pump, coolant channels or fuel channels within a combustion engine block of a drive motor, electrical lines made of materials such as copper, for example, and blood vessels for transporting blood in the body of a human or an animal.

The calculation of the minimal cross-sectional area of interspaces between two blades of a turbomachine is very complex. This applies especially if the intention is to calculate, for the mass flow, the actual minimal cross-sectional area which arises from the measurement of the interspace between two respective blades. Expressed more generally, the calculation of the minimal cross-sectional area is complex and laborious in the case of an irregular geometry of the channel. An irregular geometry is understood to mean a geometry which is not describable by, or does not contain, simple geometric elements such as a straight line, cube, square, sphere, circle, cylinder and cone, for example.

Not only in the case of blades of a blade ring are the measured coordinates of the channel wall or the channel walls typically an input parameter for the calculation of the minimal cross-sectional area in accordance with the present disclosure. However, as an alternative to that or in addition, it is possible to use target coordinates, which for example originate from computer-aided design (CAD) construction data for the channel. In an extension of the computer-implemented method according to an aspect of the disclosure, the determination of the coordinates, especially with at least one coordinate measuring machine, can therefore be part of the method and an arrangement can include not only the apparatus for determining the geometric boundary for a mass flow, for an energy flow, or for a flow of force through a channel having a channel wall, but also at least one coordinate measuring machine for determining the coordinates.

The term coordinate measuring machine includes any types of machines that can be used to determine coordinates of workpieces. In one class of coordinate measuring machines, the coordinates are surface coordinates, i.e., coordinates of surface points of workpieces are determined. Another class of coordinate measuring machines is alternatively or additionally capable of determining coordinates inside workpieces. This class includes coordinate measuring machines which utilize invasive radiation that penetrates the material of the workpiece and in particular measure the intensity of the radiation that is transmitted through the workpiece. Typically, radiation is transmitted through the workpiece from different directions and the results of the radiation transmission are taken as a basis to carry out a computer-assisted reconstruction of the scanned workpiece. Such processes are also referred to as computed tomography (CT). However, the term coordinate measuring machine also includes conventional coordinate measuring machines, for example machines with a portal design or gantry design, horizontal arm machines and articulated-arm machines. The term coordinate measuring machine also covers machines which, although not primarily designed as coordinate measuring machines, are set up to work like a coordinate measuring machine. These machines have at least one measuring sensor which is used to determine the coordinates. Robots, for example robot arms with rotary joints to which a sensor for capturing the workpiece surface (for example an optical sensor) is fastened instead of a tool, or machine tools to which a measuring sensor (for example a tactile sensor) is fastened instead of a machining tool or in addition to a machining tool, are known. Also known for example are hexapod mechanisms, to which a sensor for capturing the workpiece surface (for example a tactile sensor) is fastened instead of a machining tool.

The term coordinate measuring machine also includes 3-D scanners. For example, triangulation-based systems, such as laser scanners and projection sensors, are particularly advantageous here, since they can generate many measurement points with their 3-D coordinates in a short period of time. Projection sensors project a pattern, e.g., strip pattern, over a surface area onto the object for measurement and capture images of the object for measurement together with the projected pattern using at least one image capturing unit (camera). The 3-D coordinates of surface points of the object for measurement can be determined by evaluating the image recordings. In order to completely capture an object for measurement or the surface of the object for measurement, only one measurement position is often not enough, and therefore the relative position of the 3-D scanner with respect to the object for measurement is usually repeatedly changed. This positioning can take place here manually (in hand-held fashion), or else semi-automatedly or automatedly, for example by using a robot to guide the 3-D scanner. The change in position can also or additionally be realized by a movement of the object relative to the 3-D scanner, for example by a rotary stage.

With regards to the disclosure, coordinate measuring machines with optical sensors, for example the aforementioned projection sensors, cameras for creating one-dimensional and multi-dimensional images and laser scanners are particularly advantageous.

In particular, a test plan can be defined or received in a known manner, according to which the coordinates of the channel and, in particular, the channel wall are measured. The test plan can define which measurement points and/or measurement regions are measured.

Returning to the determination of the smallest cross-sectional area of the channel, it is often not possible to determine the smallest cross-sectional area in an appropriate timeframe. For example, in the case of the aforementioned interspaces between blades of a turbomachine, the smallest cross-sectional area is not a plane area since the opposing blades have surfaces which have a continuously toroidally curved profile in their extent along the radial direction of the turbomachine. Moreover, the channels formed between the blades of the turbomachine typically taper or expand in the flow direction. This also makes a calculation of the smallest cross-sectional area more difficult.

To determine the smallest cross-sectional area, it is possible to take individual distance measurements in the vicinity of the theoretically expected smallest cross-sectional area, and then combine the individual distances by calculation with weights to form a surface area. This approach does not allow an accurate statement to be made regarding position, shape or size of the geometric area in comparison with the fluid-mechanically defined area. Moreover, there are more non-measured (“blind”) regions than measured regions. These discrepancies hinder turbomachine designers in the development and operation and maintenance of turbomachines. Moreover, the smallest cross-section areas which often have a curved extent and are consequently three-dimensional (3-D) surfaces have been approximated by two-dimensional (2-D) surfaces.

### SUMMARY

It is an object of the disclosure to provide a method for determining a geometric boundary for a mass flow, for an energy flow, or for a flow of force through a channel having a channel wall. A further object of the disclosure is that of providing a corresponding apparatus.

According to an exemplary embodiment of the disclosure, the geometric boundary is determined as smallest cross-sectional area of the channel or a channel section. In particular, a simple and accurate determination of the position, shape and size of the smallest cross-sectional area of the channel or the channel section is made possible. If reference is made to a channel hereinbelow or in the claims, this can also be understood to mean a section of a channel.

It is proposed, for modeling and/or describing cross-sectional areas of a channel, to use an area of tessellation (i.e., a tiled area) with a gap-free and overlap-free arrangement of polygonal plane tiles. In this context, the literature also uses the term tessellation, albeit frequently with a restriction to triangular tiles. Even if the use of only triangular tiles that make up the area of tessellation has advantages, especially in relation to a simple and unique mathematical and/or numerical description, the scope of the present disclosure does not preclude the additional or exclusive use of other polygonal plane tiles as elements of the area of tessellation. Therefore, there can also be a description of the area of tessellation, in which polygonal tiles with a different number of corners occur.

In particular, the area of tessellation can be described exclusively and/or completely by the position and, in particular, the coordinates of the corner points of the tiles if the subsets of the corner points in each case representing the corner points of the same tile are also defined or uniquely ascertainable. Such a definition or determination is easily possible in the case of exclusively triangular tiles.

Reference can also be made to a mesh as an equivalent to an area of tessellation. The corner points of the area of tessellation correspond to nodes of the mesh, and the straight edges of the tiles correspond to straight connections between the nodes of the mesh.

Once the area of tessellation is known as a description/model of the cross-sectional area, the overall area of the area of tessellation, as an approximation to the cross-sectional area, can easily be determined by virtue of adding the areas of all tiles. As the number of corners or tiles increases, the error of the approximation becomes smaller. Thus, it is possible to meet specifications with regards to the accuracy of the description in the case of a sufficient number of corner points/tiles.

The considered geometry is a channel, on the channel wall of which the edge points of the cross-sectional area are located. It is possible to also describe the channel wall as an area of tessellation. The previous description of possible exemplary embodiments of the area of tessellation also applies to the channel wall, wherein the channel wall and the cross-sectional area can be described using the same type of area of tessellation or different types of area of tessellation. However, it is not mandatory to describe the channel wall as an area of tessellation. In particular, it is for example sufficient to provide merely a plurality of points on the channel wall by way of their in particular three-dimensional coordinates in a suitable coordinate system. The definition of tile edges or straight connections between the points on the channel wall is not mandatory. However, in an exemplary embodiment, the channel wall is described as an area of tessellation made of triangular, plane tiles. In this description, a “point on the channel wall” is understood to mean that the point is part of an area delimiting the flow or the flux in the channel. With regards to a channel wall, reference can also be made to an enveloping surface.

It is also provided that the method for determining a geometric boundary, which describes the cross-sectional area as an area of tessellation, be carried out as a computer-implemented method. The method steps described hereinbelow are advantageously executed in computer-implemented fashion since numerous machine operations which lead to a quick and accurate determination of the smallest cross-sectional area can be executed.

The determination of the smallest cross-sectional area is based on the information about the geometry of the channel, which, as mentioned above, may optionally be a section of a longer channel. The geometry of the channel is given by the geometry of the channel wall or the channel walls and is available to the computer or computer network executing the method. Even if it is typical, it is not mandatory to supply the computer or the computer network with coordinates of a plurality of points on the channel wall. For example, the computer or the computer network can also independently determine points on the channel wall if it has available the geometric description of the channel wall. In particular, geometric descriptions which describe the extent of the channel wall in the style of a vector graphic and/or by mathematical functions, which in particular can also have piecewise definitions, for example by polygonal chains, are also possible. However, in many cases the geometric description of the channel wall is based on measurement results from the measurement using at least one coordinate measuring machine. In these cases, the computer or computer network is typically supplied with the measured coordinates of a plurality of points on the channel wall.

Further, the determination of the smallest cross-sectional area is based on the information about the geometry of a first edge line of a cross-sectional area of the channel. If the channel has more than one channel wall, for example like in the case of an inner and an outer channel wall with a clear flow cross section therebetween, the determination of the smallest cross-sectional area is based on the information about the geometry of all channel walls that are required for the determination of the smallest cross-sectional area.

The computer-implemented method therefore uses first edge points of a first edge line of a cross-sectional area of the channel as a starting point. Thus, coordinates of these first edge points are received or present in the computer or computer network. In particular, the method can also include the determination of these coordinates from the information present about the geometry of the first edge line and consequently the creation of the appropriate coordinates.

There is a corresponding procedure for each further channel wall if at least one further channel wall should be taken into account during the determination of the smallest cross-sectional area, with it also being possible, for example, to receive coordinates of first edge points on a first channel wall at the start of the execution of the method and during the execution of the method determine coordinates of first edge points on a second channel wall from the information about the geometry of a first edge line on the second channel wall.

Further, a first cross-sectional area is received or created as area of tessellation, as described above, when the method is executed, with this first cross-sectional area being bounded by the first edge points of the first edge line(s). In other words, the first edge points are located on the first edge line or the first edge lines. As corner points, all first edge points belong to the area of tessellation which describes the first cross-sectional area. In particular, the set of first edge points of the first edge line(s) contains all edge points of the area of tessellation. Therefore, there are no further corner points of tiles at the edge of the area of tessellation in this case. However, it is possible, in particular, that a plurality of the first edge points are received or present at the outset, and additional first edge points are subsequently created or additionally received when the method is executed.

It should be observed here that the course of the edge line(s) need not be known throughout in order to carry out the method. Rather, a case arising in practice can be that a channel wall has depressions, openings or other gaps, which advantageously remain unconsidered when determining the smallest cross-sectional area. If need be, the gap can then be closed in the corresponding regions of the channel wall, for example by interpolation. However, closing a gap is not required in any case either. For example, it can be the case that no edge line taken into account during the determination of the smallest cross-sectional area by the method extends in the region of the gap. However, should this be the case, it can for example be sufficient for a respective edge point of the edge line to be defined in close proximity to the gap on opposite sides of the gap and for these two edge points to be neighboring corner points of the same tile. In an alternative to that or in addition, at least one additional edge point can be defined between these two edge points in the style of an interpolation (e.g., on a straight connection between the two edge points). For example, this can be implemented if the distance between the two edge points exceeds a predetermined maximum value.

Since there is an infinite number of areas of tessellation for each set of edge points, it is possible, broadly speaking, to define any first cross-sectional area with the first edge points present (also referred to as present set of first edge points) in order to start an optimization that continues until the smallest cross-sectional area is obtained. In this case, it is not necessary, albeit possible, to determine the associated smallest cross-sectional area for the set of first edge points. Instead, the method according to an exemplary embodiment of the disclosure should only lead to the determination of the smallest cross-sectional area for a channel or channel section, and hence also for other desired edge lines or sets of edge points.

Although this has already been mentioned at least implicitly at the outset and in the description of the provided solution, it should once again be stressed that the cross-sectional areas of the channel generally are three-dimensional (3-D) surfaces, i.e., areas which do not extend only within a single plane in each case. The area of tessellation with the gap-free arrangement of polygonal plane tiles is suitable for describing real curved 3-D surfaces to a good approximation. Moreover, the overall area of an area of tessellation is easily calculable by summing the areas of the individual tiles. Further, the description of the cross-sectional area as an area of tessellation allows a modification of the shape thereof in a simple manner, by virtue of at least one corner point of one tile, in general a plurality of corner points and in particular all corner points, of the area of tessellation being displaced in space. Each corner point can be displaced continuously in space. In this case, boundary conditions which will be discussed in detail need to be observed for the respective types of corner points. The term “boundary condition” is understood in the mathematical sense and does not necessarily refer to the area boundary. In particular, types of corner points are edge points and, in contrast thereto, inner corner points.

One boundary condition for the edge points is that they are also located on the channel wall after the displacement in space (i.e., after the change in their position), wherein, at least temporarily, this condition can also be kept only approximately during the search for the smallest cross-sectional area. A possible boundary condition for the displacement of the inner corner points and also for the displacement of the edge points, which enables the detection of the smallest cross-sectional area in time-saving fashion, will be described below. Otherwise, one boundary condition for the displacement of the inner corner points can be that they do not become an edge point and/or that they are not displaced beyond the channel wall.

The use of a first cross-sectional area as a starting point for the determination of a minimized cross-sectional area by iterative determination of further cross-sectional areas as areas of tessellation is also proposed. At least one corner point of the area of tessellation is displaced in each iterative step until one of the further cross-sectional areas is obtained. In particular, an iterative step can be considered complete once a modified cross-sectional area is present, for which the overall area is calculated in particular by summation of the size of the areas of all tiles in the area of tessellation. Naturally, in comparison with a previously valid cross-sectional area, the sizes of the areas of the individual tiles only need to be recalculated if at least one corner point of the respective individual tile was displaced. However, an iterative step can also be considered complete if a specification for carrying out the iterative step was met. For example, the specification can be that a displacement in space should be calculated (in relation to the area of tessellation present at the start of the iterative step), to be precise in accordance with a boundary condition, for all corner points or for a set of corner points ascertainable in accordance with the specification. For example, the boundary conditions are that the displacement of the corner point or the corner points leads to a smaller overall area of the area of tessellation. A specific configuration of such a boundary condition will be discussed below. Therefore, if a displacement of a specifically considered individual corner point or a specifically considered set or subset of the corner points does not lead to a smaller overall area, a decision can be made that the corner point or the corner points is/are not displaced.

Further, it is provided to terminate the iteration when a specified termination criterion is met. For example, the termination criterion can be that an iterative step or a plurality of iterative steps do not obtain a substantially smaller cross-sectional area than that obtained previously for an determined (so-called “further”) cross-sectional area. For example, “substantially smaller” can be defined by a specified limit value. Alternatives to this termination criterion are well known in relation to the methods for finding an optimum (minimum or maximum). For example, the termination criterion can use the rate of change or the gradient of the change of the size of the cross-sectional area. For example, it is possible to execute a so-called gradient method or gradient descent method.

Since the intention is not to determine the smallest cross-sectional area only for a specified edge line but instead determine the smallest cross-sectional area of a channel or channel section, it is not only inner corner points of the area of tessellation but also edge points of the area of tessellation that are displaced in space during the iteration.

Therefore, the following is provided: A computer-implemented method for determining a geometric boundary for a mass flow, for an energy flow, or for a flow of force through a channel having a channel wall, wherein
coordinates of first edge points of a first edge line of a cross-sectional area of the channel are received or present, with the edge points being located on the channel wall,
using the first edge points, a first cross-sectional area is received or created as an area of tessellation with a gap-free and overlap-free arrangement of polygonal plane tiles of the area of tessellation, the first edge points being corner points of tiles of the area of tessellation, and the first edge points and all further, inner corner points of the tiles defining the first cross-sectional area,
further cross-sectional areas are determined by iteration as areas of tessellation of the aforementioned type,
the position of both edge points and inner corner points is varied during the iteration, and
the iteration is terminated when a specified termination criterion is met, and information is output about a smallest cross-sectional area for which, with regards to the areas of tessellation from the iteration, the overall area of all tiles of the respective area of tessellation is minimized.

The coordinates of the edge points and the inner corner points can relate to any desired three-dimensional coordinate system. For example, the coordinate system is a Cartesian coordinate system with an origin located in the spatial region of the channel.

The information about the smallest cross-sectional area that is output can differ depending on the configuration of the method. For example, it can only be the size of the smallest cross-sectional area that is output. In an alternative to that or in addition, the at least one edge line of the smallest cross-sectional area, for example, can be output. Furthermore, in an alternative to that or in addition, the three-dimensional coordinates of all inner corner points and all edge points can be output for example for the area of tessellation as smallest cross-sectional area for which, with regard to the areas of tessellation within the iteration, the overall area of all tiles of the respective area of tessellation is minimized. The smallest cross-sectional area determined during the iteration need not be the absolutely smallest cross-sectional area. One possible reason for this is already found in the fact that the smallest cross-sectional area is only described approximately by the identified area of tessellation. Further, the iteration can have already been terminated in accordance with the specified termination criterion when the smallest cross-sectional area was not yet determined. However, the determined smallest cross-sectional area can also be an only local smallest cross-sectional area, with the size of the area not representing the absolute minimum in the channel or channel section. This may be countered, in particular, by virtue of carrying out the method again with a different first edge line.

Typically, edge points are displaced during the iteration, in such a way in each case that the respective edge point continues to be located on the channel wall. By displacing the edge points such that these continue to be located on the channel wall, the geometry keeps in conformity with the channel wall and, on the other hand, finding the smallest cross-sectional area of the channel is rendered possible in a simple manner.

As already mentioned, this can only apply approximately, at least temporarily, in particular for reasons relating to the numerical implementation of the method and for facilitating the calculation of the displacement of the edge points. However, it is typical that edge points temporarily located next to the channel wall are displaced to the channel wall, at least once the specified termination criterion is met or immediately thereafter. Typically, the displacement to the channel wall takes place in each iterative step. Thus in particular, preliminary new three-dimensional coordinates of a point on the channel wall can be determined in at least one iterative step for edge points, by virtue of the respective edge point reaching its preliminary new position defined by the preliminary three-dimensional coordinates by way of displacement, from its previous position, in the tangential plane of the channel wall at the previous position, with, at a later stage (and typically within the same iterative step) there being a displacement of the respective edge point from the preliminary new position to its final new position on the channel wall should the preliminary new position not be located on the channel wall. The tangential plane in contact with the channel wall at the previous position of the edge point represents a good approximation to the profile of the channel wall in the case of small displacements of the location of the edge point. At the same time, the displacement in the tangential plane ensures that the edge point is not displaced away from the channel wall by a substantial distance and, in particular, is not displaced perpendicular or approximately perpendicular to the profile of the channel wall. However, the displacement in the tangential plane is only one option for ensuring the displacement of the respective edge point approximately on the channel wall. As an alternative or in addition, this can be ensured, for example, by the boundary condition that the distance of the displaced edge point from the channel wall must not be larger (for example not even temporarily) than a specified maximum value.

In particular, new three-dimensional coordinates can be determined for edge points and/or for inner corner points in each iterative step, by meeting the local condition that the sum of the areas of all tiles whose corner is defined by the respective corner point is minimal while the three-dimensional coordinates of all other corner points remain unchanged.

In principle, this local condition can be used in two different cases. Firstly, according to a first exemplary embodiment, there can initially be no displacement of a corner point in the iterative step before the displacement of the corner point that results from meeting the local condition has been calculated for all corner points to possibly be displaced in the iterative step (i.e., for all corner points to which the local condition should be applied). Then again, according to a second exemplary embodiment, this local condition can be used after at least one corner point has already been displaced (in particular by using the local condition) in the iterative step. Therefore, the process can be executed for example successively for the corner points in the second case, i.e., the process contains the use of the local condition and the displacement of the corner point. It goes without saying that it is possible that these two cases are combined with one another. Therefore, for example, a displacement can initially not be executed during the iterative step in a local region of the cross-sectional area before the displacement according to the local condition has been determined for corner points in this local region, and the same procedure can subsequently be performed for another local region or for individual corner points.

It is also possible that the displacement of corner points according to the aforementioned local condition is determined and/or carried out merely in relation to edge points or merely in relation to inner corner points in the respective iterative step or in a portion of the iterative steps.

As an alternative or in addition, a different local condition can be defined, in particular for a local region having a plurality of corner points. For example, the local condition in that case can be that the sum of the areas of all tiles whose corners are defined by the corner points in the local region is minimal. Depending on the number of corner points in the local region, this can be achieved by virtue of the local minimal area being determined by repeated displacement of individual corner points, i.e., the sum of the areas of the involved tiles can be determined for different combinations of the position of the corner points in the local region, and the minimum of the sum of the areas can be determined in this way. In the local condition specified here, it is possible to consider tiles that form the respective local region, but do not all have a common corner point. However, these tiles typically form a contiguous area. It is also possible that one of the specified local conditions is applied to the edge points and the other local condition is applied to the inner corner points.

In particular, preliminary new three-dimensional coordinates of a point on the channel wall can be determined for edge points in each iterative step, by meeting the local condition that the sum of the areas of all tiles whose corner is defined by the respective corner point is minimal while the three-dimensional coordinates of all other corner points remain unchanged, and by meeting an additional displacement condition (which is also a boundary condition in the mathematical sense). This additional displacement condition can be that the respective edge point may reach its preliminary new position defined by the preliminary three-dimensional coordinates only by way of displacement, from its previous position, in the tangential plane of the channel wall at the previous position. Subsequently or at a later stage, there is a displacement of the respective edge point from the preliminary new position to its, with regards to the iterative step, final new position on the channel wall should the preliminary new position not be located on the channel wall. The “tangential plane of the channel wall at the previous position” is a tangential plane which is in contact with the channel wall at least at the previous position, and hence in the not yet displaced edge point. Attention has already been drawn to advantages of this type of displacement for the edge points.

Furthermore, according to an exemplary embodiment of the disclosure, an apparatus for data processing is provided which includes means for executing the method, in particular the method in one of the configurations described. The apparatus may include, for example, a single computer or a computer network, or may include the computer or the computer network. The computer or at least one of the computers may be, with respect to its method of operation, in particular an analog computer, a digital computer, and/or a hybrid computer. In terms of its size and design, it may be a smartphone, a personal digital assistant (PDA), a tablet computer, an embedded system (e.g., embedded in the control computer of a coordinate measuring machine), a single-board or multi-board computer, a personal computer (PC), a desktop computer, a workstation computer, a host computer or server integrated into a computer network, a thin client computer, a netbook, a notebook, a laptop, a mainframe computer, or a supercomputer, wherein some of said types can also be implemented with a single computer, such as a multi-board PC. Furthermore, the computer or at least one of the computers may have one or more central processing units (CPU) and/or one or more computing cores per CPU. Graphics cards or other dedicated cards with processing units that are part of a computer may also be configured to carry out the method, either exclusively or in combination with other computers or processing units.

Furthermore, attention should be drawn to the fact that although the computer is typically prompted by a computer program to execute the method, the means for executing the method may also at least include a hardware-realized, typically programmable arrangement (for example an arrangement of logic gates), for example an application-specific integrated circuit (ASIC), a programmable logic device (PLD) or a field programmable gate array (FPGA).

Moreover, according to an exemplary embodiment of the disclosure, a computer program is provided which includes instructions that, upon the execution of the program by a computer, prompt said computer, or by a computer network, prompt said computer network to execute the method, in particular execute the method in one of the configurations described.

A data carrier signal which transmits the computer program, and a non-transitory computer-readable medium are also provided. The computer-readable medium includes instructions that, upon the execution by a computer, prompt said computer, or by a computer network, prompt said computer network to execute the method, in particular the method in one of the configurations described.

The aforementioned computer network or one of the aforementioned computer networks can be a local or a non-local network, or a combination thereof. In particular, a local network can be a body area network (BAN), a wireless body area network (WBAN), a personal area network (PAN), a wireless personal area network (WPAN), a local area network (LAN) or a wireless LAN (WLAN). In particular, a non-local network can be a metropolitan area network (MAN), a wide area network (WAN), a global area network (GAN), a virtual private network (VPN), or storage area network (SAN).

The computer-readable medium can also be referred to as a storage medium and is, for example, a digital medium such as a compact disk (CD), a disk, a digital versatile disk (DVD), a hard disk drive, a memory card or a mass storage means, or else can be an analog computer-readable medium such as a text (which for example is a printout of program code), an image, an arrangement of images or an analog plate-shaped or disk-shaped data carrier.

The disclosure also relates to an arrangement having the apparatus for data processing and having a coordinate measuring machine which is configured to measure coordinates of the channel wall as input parameter for carrying out the computer-implemented method. In particular, the apparatus for data processing can be at least partially integrated in the coordinate measuring machine. However, the apparatus can also be realized separately from the coordinate measuring machine.

### BRIEF DESCRIPTION OF THE DRAWINGS

The disclosure will now be described with reference to the drawings wherein:

FIG. 1 schematically shows an arrangement which includes a coordinate measuring machine and a data processing device for determining a geometric boundary for a flow or flux,

FIG. 2 shows a flowchart which schematically represents, in a simple manner, a procedure when determining a geometric boundary for a flow or flux through a channel,

FIG. 3 shows a portion of an area of tessellation which is represented by a triangular mesh of the edges of the tiles, for a cross-sectional area extant at an earlier time,

FIG. 4 shows a portion of an area of tessellation, modified vis-à-vis the area of tessellation from FIG. 3, for a cross-sectional area extant at a later time,

FIG. 5 schematically shows part of a turbomachine including two blades,

FIG. 6 shows an object which forms a channel with a channel wall that does not extend continuously at one point,

FIG. 7 shows the object from FIG. 6 in an enlarged representation in the region of the discontinuity, and

FIG. 8 shows a blood vessel with a plurality of branches.

### DESCRIPTION OF EXEMPLARY EMBODIMENTS

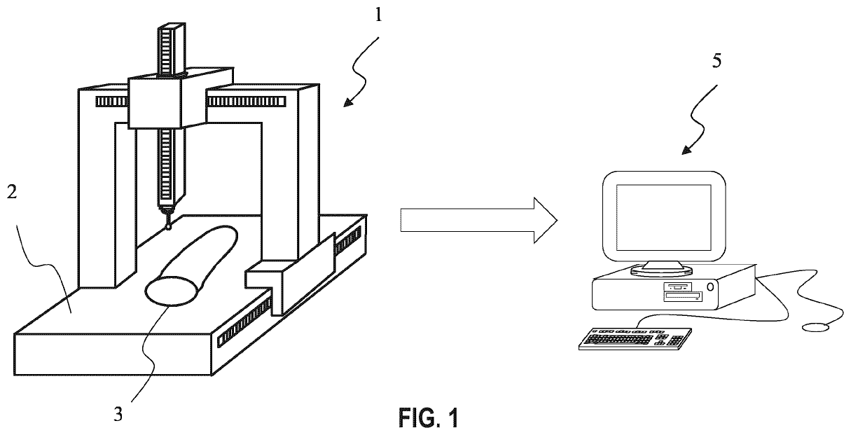

FIG. 1 shows an arrangement having a coordinate measuring machine 1 and having a data processing device 5. In FIG. 1, the coordinate measuring machine 1 is depicted as a gantry-type coordinate measuring machine. However, this is merely an example, and the coordinate measuring machine can be of any type, for example also a coordinate measuring machine carrying out measurements using invasive radiation such as x-ray radiation, a laser scanner or a projection sensor. Unlike the depiction, the coordinate measuring machine may also include a hand-guided sensor and/or pattern projector. Types of coordinate measuring machines and sensors were already mentioned above.

A workpiece 3 which has a channel with an irregularly shaped channel wall is situated in a measurement region, in the example here on a measurement table 2, of the coordinate measuring machine 1. The data processing device 5 depicted in FIG. 1 has been drawn as a desktop computer. Alternatively, this can be any other type of data processing device, in particular also a device having a plurality of computers which are connected to one another by way of a remote data transmission network, for example. The data processing device carries out its functions, in particular under the control of at least one computer program.

The data processing device 5 receives measurement results regarding the measurement of the workpiece 3 from the coordinate measuring machine 1, as indicated by an arrow. The measurement results contain coordinates of the channel wall of the workpiece. The coordinates can, but need not, describe the shape of the channel wall in full. Instead, additional information, for example from CAD planning data for the workpiece 3, can also be present or obtained, and this additional information, together with the measured coordinates of the channel wall, describe the shape of the channel wall.

The data processing device 5 can also be part of the coordinate measuring machine 1 and, in the process, also fulfill a function for controlling the coordinate measuring machine 1.

In an alternative to that or in addition, a data processing device such as the data processing device 5 can start and/or trigger the procedure for measuring the workpiece 3 or any other measurement object, for example when at least one computer program is executed.

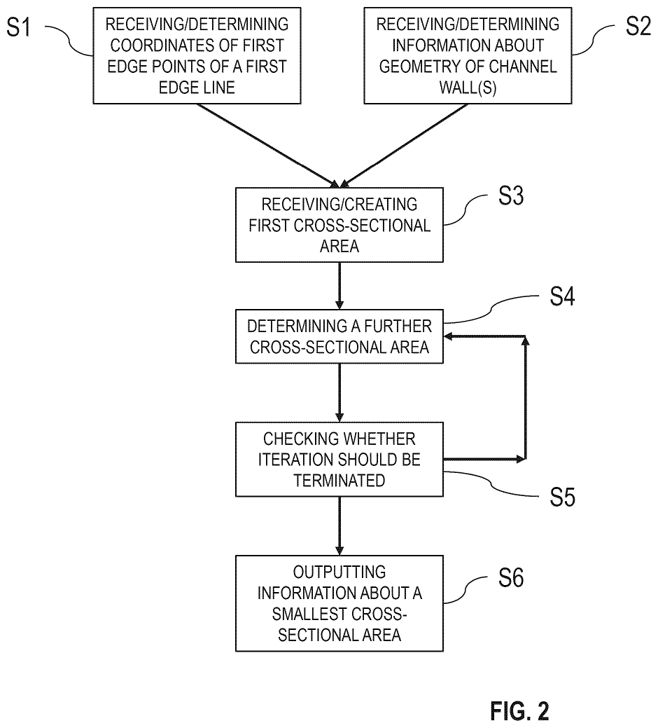

A procedure of a computer-implemented method for determining a geometric boundary for a flow or flux through a channel, specifically by way of or including determination of a smallest cross-sectional area of the channel is now described hereinbelow with reference to FIG. 2.

In a first step S1, coordinates of first edge points of a first edge line of a cross-sectional area of the channel are received and/or determined, with the edge points being located on the channel wall of a channel whose smallest cross-sectional area is intended to be determined. If the channel has more than one channel wall, for example an inner and an outer channel wall, then coordinates of first edge points of a further edge line of the cross-sectional area of the channel can also be received and/or determined in the first step S1 for the respective further channel wall.

In particular, a person can specify the first edge line(s) in full or in part, for example by defining coordinates of the edge line. In an alternative or in addition, a device such as the data processing device 5 shown in FIG. 1, for example, can automatically define the first edge line(s) by way of the coordinates of the first edge points. In particular, the geometry of the channel wall is already known to this end, either in full or in part (for example in the local region of the first edge line).

Optionally, information about the geometry of the channel wall or the channel walls of the channel is received and/or determined in a further step S2, which can be executed before, after and/or at the same time as the first step S1.

For the execution of the further steps of the method, the required information about the geometries of the channel wall and the edge line(s) of a first cross-sectional area is now available.

Using the first edge points in a further step S3 of the method, a first cross-sectional area is received or created as an area of tessellation with a gap-free and overlap-free arrangement of polygonal plane tiles of the area of tessellation, the first edge points being corner points of tiles of the area of tessellation, and the first edge points and all further, inner corner points of the tiles defining the first cross-sectional area.

At this point, it should be observed that it is possible, but not necessary, to initially receive and/or determine the coordinates of the edge line(s) of the first cross-sectional area and in turn create the first cross-sectional area therefrom as an area of tessellation. Rather, it is also possible, for example, to determine and/or receive a data record which describes the first cross-sectional area as an area of tessellation. Since the area of tessellation also has the edge points, the points of the first edge line(s) are also defined thereby. The schematic representation of the procedure of the method looks different to FIG. 2 in this case. However, in any case, a first cross-sectional area is available as an area of tessellation for the steps of the method that follow step S3. For example, knowledge of the three-dimensional coordinates of all corner points (inner corner points and edge points) of the area of tessellation is sufficient to define the area of tessellation, as already mentioned above.

Should the distances between mutually neighboring corner points be too large at least for some tiles in the area of tessellation now present (and hence should the tiles have edge lengths that are too long), the mesh corresponding to the area of tessellation can now be refined in an optional step. For example, tiles that are too large are subdivided into a plurality of smaller tiles in the process. In particular, the maximally admissible edge length of tiles can also be dependent on the local curvature of the cross-sectional area. Therefore, it is also possible to subdivide or fuse tiles (i.e., create one tile from a plurality of tiles or create a smaller number of tiles) during and/or between the iterative determination of further cross-sectional areas.

As already mentioned, a triangular mesh, which corresponds to an area of tessellation including or consisting exclusively of plane triangular tiles, is an advantageous way of describing the first cross-sectional area and the further cross-sectional areas, which are created when the method is executed.

In a further step S4, following step S3, a further cross-sectional area is determined as an area of tessellation, with the further cross-sectional area being created by modifying the area of tessellation previously present. This is the first cross-sectional area in the first execution of step S4. Step S4 is part of an iteration, just like the subsequent step S5, in which a check is carried out as to whether the iteration should be terminated. Possible termination criteria have already been discussed above. According to an exemplary embodiment of the disclosure, it is generally both the position of edge points and the position of inner corner points of the area of tessellation that is modified during the iteration.

If the termination criterion of the iteration is satisfied, step S5 is followed by step S6 with an output of information about a smallest cross-sectional area, for which, with respect to the areas of tessellation of the iteration (i.e. all areas of tessellation determined during the iteration), the overall area of all tiles of the respective area of tessellation is minimized. In particular, the size of the smallest cross-sectional area and/or the coordinates and/or the profile of the associated edge line(s) are output.

For example, the further area of tessellation can be determined, either in the above-described step S4 or in another exemplary embodiment of the method, as set forth below: One of the above-described local conditions is applied to each of the corner points of the area of tessellation present; typically, the same local condition is applied to all corner points. This yields a displacement of the respective corner point. In the exemplary embodiment, the constraint that the displacement can occur exclusively on the respective tangential surface should be observed for edge points. After the displacement has been determined for all corner points, the displacement is carried out, i.e., the displacement of each corner point does not depend on the displacement of the other corner points. To accelerate the computational process, apparatuses with a large number of processors operating in parallel, as is the case of graphics cards, for example, are suitable.

An exemplary embodiment of a procedure for finding a smallest cross-sectional area of a channel is now described below with reference to formulas. In so doing, formulas and explanations from the article “Constructing Triangular Meshes of Minimal Area” by Wenyu Chen, Yiyu Cai and Jianmin Zheng in “Computer-Aided Design & Applications” 5(1-4), 2008, 508-51 (DOI: 10.3722/cadaps.2008.508-518), specifically in particular from section 3.1 of this article, are drawn upon with respect to the so-called plateau problem in discrete form. This relates to formulas and explanations in the case of a fixedly specified or unchangeable edge line. These formulas are extended to the case of a changeable edge line, which is located on the enveloping surface defined by a channel wall in each case.

Below, Pₖ denotes a point coordinate of the point P with index k. A vector between two [symbol] points is symbolized by an arrow over the symbols of two point coordinates, for example [symbol] . D denotes the set of triangles in an area, where each triangle is described for example by the corner points Pₖ, Pₗ, Pₘ with the indices k, l, m.

The surface area A of the area to be minimized can be expressed by:

$$A = {\sum }_{t = < k , l , m > ϵ D} \frac{1}{2} \vert \vec{{P}_{l} {P}_{m}} \times \vec{{P}_{l} {P}_{k}} \vert = {\sum }_{t = < k , l , m > ϵ D} \frac{1}{2} \sqrt{{( \vec{{P}_{l} {P}_{m}} \times \vec{{P}_{l} {P}_{k}} )}^{2}} \qquad ( 1 )$$

Here, <k, l, m> denotes the set of indices k, l, m. With regards to the summation symbol Σ, the entire expression t=<k, l, m>ϵD means that the sum should be formed over all corner points of the set of triangles in the area A. The symbol x denotes the cross product of the vectors in front and behind thereof.

Now the change in the surface area A when changing any desired inner point Pₐ is considered; in the following equation, this is expressed by the partial derivative of the surface area A with respect to the change (displacement) of the point Pₐ:

$$\frac{\partial A}{\partial {P}_{a}} = {( \frac{\partial A}{\partial {( {P}_{a} )}_{x}} , \frac{\partial A}{\partial {( {P}_{a} )}_{y}} , \frac{\partial A}{\partial {( {P}_{a} )}_{z}} )}^{T} \qquad ( 2 )$$

Hence, the displacement can be expressed by the displacements of the components x, y, z of the point Pₐ. T denotes the transposed vector. Hereinbelow, ND(a) denotes the set of triangles in an area. These triangles adjoin the point Pₐ, i.e., the point forms a corner of all of these triangles. Inserting the right-hand side of Equation (1) into Equation (2) yields:

$$\begin{matrix}\frac{\partial A}{\partial {P}_{a}} = \frac{1}{2} {\sum }_{t = < k , l , m > ϵ D} \frac{\partial }{\partial {P}_{a}} \sqrt{{( \vec{{P}_{l} {P}_{m}} \times \vec{{P}_{l} {P}_{k}} )}^{2}} \\ = \frac{1}{2} {\sum }_{t = < a , b , c > ϵ ND ( a )} \frac{1}{2} \frac{\frac{\partial }{\partial {P}_{a}} {( \vec{{P}_{b} {P}_{c}} \times \vec{{P}_{b} {P}_{a}} )}^{2}}{\sqrt{{( \vec{{P}_{b} {P}_{c}} \times \vec{{P}_{b} {P}_{a}} )}^{2}}} \\ = \frac{1}{2} {\sum }_{t = < a , b , c > ϵ ND ( a )} \frac{{( \vec{{P}_{b} {P}_{c}} )}^{2} \vec{{P}_{b} {P}_{a}} - ( \vec{{P}_{b} {P}_{c}} \cdot \vec{{P}_{b} {P}_{a}} ) \vec{{P}_{b} {P}_{c}}}{\sqrt{{( \vec{{P}_{b} {P}_{c}} \times \vec{{P}_{b} {P}_{a}} )}^{2}}}\end{matrix} \qquad ( 3 )$$

If all these derivatives are set to zero, n equations with n variables arise, where n is the number of inner points. Setting the derivatives to zero corresponds to the aforementioned local condition that the sum of the areas of all tiles (the triangles in this case) whose corners are defined by the corner point Pₐ is minimal.

The solution supplies an optimal mesh. However, the equations are nonlinear. It is difficult to solve such a nonlinear system. Solving with justifiable outlay is not possible in the case of a mesh with a large number of points. Therefore, a local mechanism is provided, and the solution is approximated iteratively. The equation above is reformulated as:

$$\frac{\partial A}{\partial {P}_{a}} = \frac{1}{2} C {P}_{a} + \frac{1}{2} {\sum }_{t = < a , b , c > ϵ ND ( a )} \frac{( \vec{{P}_{b} {P}_{c}} \cdot {P}_{b} ) \vec{{P}_{b} {P}_{c}} − {( \vec{{P}_{b} {P}_{c}} )}^{2} {P}_{b}}{\sqrt{{( \vec{{P}_{b} {P}_{c}} \times \vec{{P}_{b} {P}_{a}} )}^{2}}}$$

$$where$$

$$C = {\sum }_{t = < a , b , c > ϵ ND ( a )} \frac{{( \vec{{P}_{b} {P}_{c}} )}^{2} ( \begin{matrix}1 & 0 & 0 \\ 0 & 1 & 0 \\ 0 & 0 & 1\end{matrix} ) − ( \vec{{P}_{b} {P}_{c}} ) {( \vec{{P}_{b} {P}_{c}} )}^{T}}{\sqrt{{( \vec{{P}_{b} {P}_{c}} \times \vec{{P}_{b} {P}_{a}} )}^{2}}}$$

is a 3×3 matrix. Using

$$\frac{\partial A}{\partial {P}_{a}} = 0$$

(aforementioned local condition) leads to the following:

$${P}_{a} = − {C}^{− 1} {\sum }_{t = < a , b , c > ϵ ND ( a )} \frac{( \vec{{P}_{b} {P}_{c}} \cdot {P}_{b} ) \vec{{P}_{b} {P}_{c}} − {( \vec{{P}_{b} {P}_{c}} )}^{2} {P}_{b}}{\sqrt{{( \vec{{P}_{b} {P}_{c}} \times \vec{{P}_{b} {P}_{a}} )}^{2}}}$$

C⁻¹ is the inverse matrix to C. The equation above cannot be considered to be an explicit solution for Pₐ, since the right-hand side of the equation also contains Pₐ. However, it provides an option for updating the point Pₐ in the style of signal processing, as explained in the publication “A signal processing approach to fair surface design”, SIGGRAPH '95: Proceedings of the 22nd annual conference on Computer graphics and interactive techniques, September 1995, pages 351-358 (https://dl.acm.org/doi/10.1145/218380.218473), by Gabriel Taubin. That is to say, the new, displaced point P̅ₐ is obtained from the point Pₐ present and the other corner points of the set ND (a) assigned thereto, i.e. all its neighboring corner points, by

$${\overline{P}}_{a} = {P}_{a} + {ΔP}_{a} = - {C}^{- 1} {\sum }_{t = < a , b , c > ϵ ND ( a )} \frac{( \vec{{P}_{b} {P}_{c}} \cdot {P}_{b} ) \vec{{P}_{b} {P}_{c}} − {( \vec{{P}_{b} {P}_{c}} )}^{2} {P}_{b}}{\sqrt{{( \vec{{P}_{b} {P}_{c}} \times \vec{{P}_{b} {P}_{a}} )}^{2}}} \qquad ( 1 )$$

Up to this point, the formulas and explanations also relate to the case of a fixedly specified or unchangeable edge line. This is now extended to the case of a changeable edge line, which is located on the enveloping surface defined by a channel wall.

The above-described procedure is now also applied to the edge points. In so doing, consideration is given to the constraint that said edge points must always remain at least approximately on the enveloping surface, i.e., at the edge of the channel.

The fact that the tangential plane of the enveloping surface at an edge point Pₑ approximates the enveloping surface in a small neighborhood E is used to this end. The assumption can be made that, for a sufficiently well-shaped surface, each iterative step is sufficiently small such that this approximation suffices.

Instead of the three degrees of freedom that occur in Equation (2), this only still contains two degrees of freedom, specifically the two degrees of freedom of the enveloping surface tangential plane of Pₑ (where this plane is spanned by the two directions t1 and t2):

$$\frac{\partial A}{\partial {P}_{e}} = {( \frac{\partial A}{\partial {( {P}_{e} )}_{t 1}} , \frac{\partial A}{\partial {( {P}_{e} )}_{t 2}} , 0 )}^{T} \qquad ( 5 )$$

$$\frac{\partial A}{\partial {P}_{e}} = {( \frac{\partial A}{\partial {( {P}_{e} )}_{t 1}} , \frac{\partial A}{\partial {( {P}_{e} )}_{t 2}} )}^{T}$$

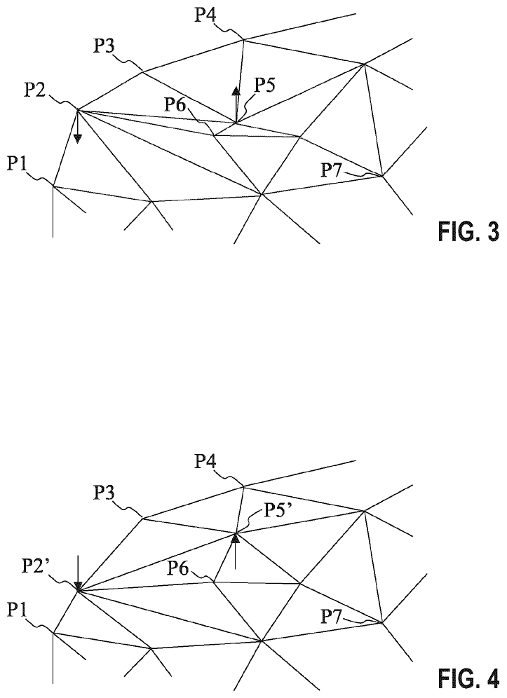

With this, the procedure described above can be applied analogously. However, P̅ₑ is subsequently projected onto the enveloping surface in order to meet the aforementioned constraint. FIGS. 3 and 4 and triangular meshes are now used to illustrate how corner points of an area of tessellation are displaced for example during the iterative procedure described above on the basis of FIG. 2. The triangular meshes each illustrate the profile of edges of an area of tessellation made of plane triangular tiles. However, the two figures show only part of an overall area of tessellation or part of an overall cross-sectional area of a channel. The displacement of only two corner points is illustrated, an edge point and an inner corner point. FIG. 3 illustrates a state at an earlier time to FIG. 4. In this case, earlier and later can relate both to a single iterative step and to times in subsequent iterative steps.

Only some of the corner points are labeled by reference signs in each of FIG. 3 and FIG. 4, to be precise using a P followed by a numeral in each case. In this case, P1, P2, P3 and P4 denote edge points, and P5, P6 and P7 denote inner corner points. Furthermore, two respective arrows are depicted in both FIG. 3 and FIG. 4; they indicate a displacement of one of the corner points. The downwardly pointing arrow starting from the edge point P2 in FIG. 3 accordingly leads to a displacement of the edge point P2 downward to a position at which the displaced edge point P2′ is located in FIG. 4. Further, the upwardly pointing arrow at the inner corner point P5 leads to a displacement of the corner point P5 upward to a position at which the displaced corner point P5′ is located in FIG. 4.

As has been explained both in general terms above and previously on the basis of the formulas, the displacement of the edge point P2 occurs in the tangential plane of the enveloping surface or channel wall, which is not depicted in FIG. 3 and FIG. 4. However, since the displacement is based in each case on a minimization of the overall area of the local tiles, the planes of the triangular tiles whose corner point is the edge point P2′ extend approximately perpendicular to the enveloping surface in FIG. 4. The tangential plane is the tangential plane that touches the enveloping surface at the non-displaced edge point P2.

With regards to the displacement of the inner corner point P5, it is evident from FIGS. 3 and 4 that the overall area of the triangular tiles whose corner point is the inner corner point P5 has become smaller. The displaced corner point P5′ no longer forms the local low point. However, since no further condition other than the minimization of the overall area in its local region (in particular of that by all triangles whose corner point is the point P5) applies to the displacement of the inner corner point P5, the displacement can as a matter of principle be implemented in any direction, not only in a plane like in the case of corner points.

The two arrows pointing upwardly and downwardly, respectively, in opposite directions in FIG. 3 and FIG. 4 only relate to a specific exemplary embodiment and a certain situation. As mentioned, the displacements can be implemented in any desired directions in the case of the inner corner points in any case.

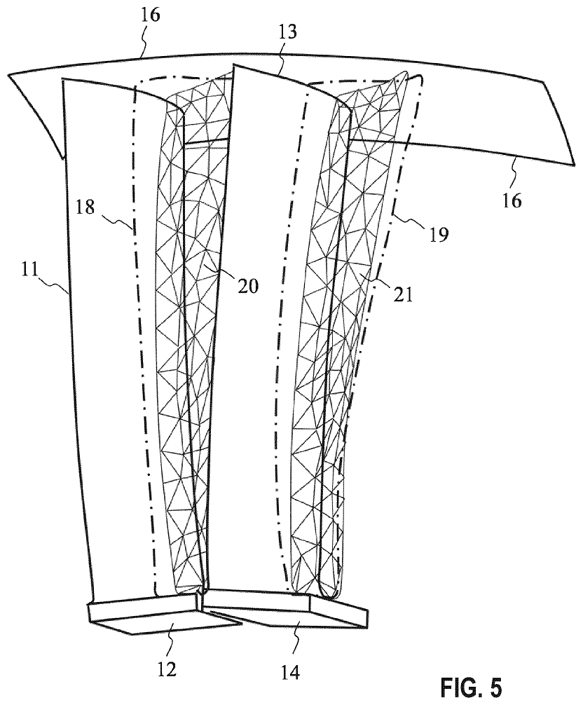

FIG. 5 shows part of a turbomachine. Two blades 11, 13 extend from sections 12, 14 of a hub of a blade wheel to a housing 16 approximately in a radial direction, wherein, when the blade wheel rotates, a left-to-right movement along the housing 16 still is possible for the ends of the blades 11, 13 depicted at the top of FIG. 5, and hence there is a respective small gap present between the blades 11, 13 and the housing 16. The blades 11, 13 extend only approximately in the radial direction because they have a curved profile along their extent from the hub of the blade wheel to the housing 16.

Further, FIG. 5 depicts two circumferential dash-dotted lines and two areas of tessellation 20, 21 consisting of triangles. The dash-dotted lines each represent the profile of a first edge line 18, 19. The edge line 19 identifiable further to the right in FIG. 5 and the area of tessellation 21 arising therefrom after an iterative calculation of further areas of tessellation are depicted as they are drawn in full. The blade at the right edge of the edge line 19 and of the area of tessellation 21 has been omitted from the illustration of FIG. 5. By contrast, the edge line 18 identifiable further to the left and the area of tessellation 20 arising therefrom are partly concealed by the blade 13.

The method according to an exemplary embodiment of the disclosure for calculating a minimized cross-sectional area for example starts with the first edge line 18 for the channel between the blades 11, 13. The first area of tessellation associated with this first edge line 18 has not been depicted. As a result of the iterative determination of further areas of tessellation in the manner described above, the area of tessellation 20 arises as an approximation of the smallest cross-sectional area.

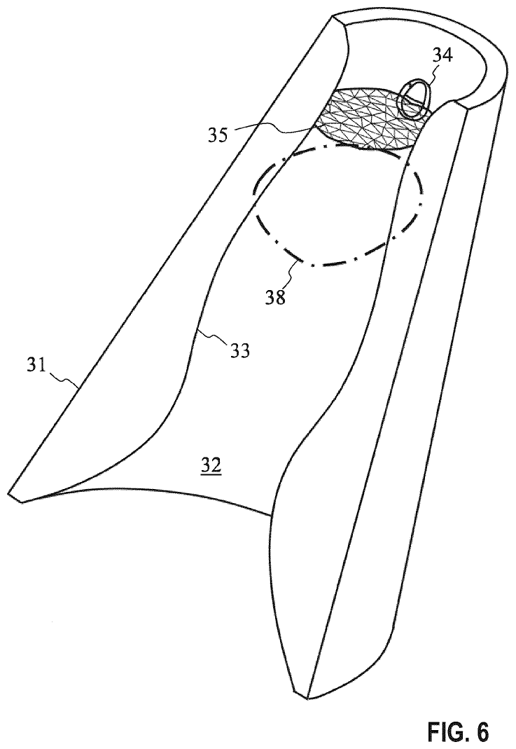

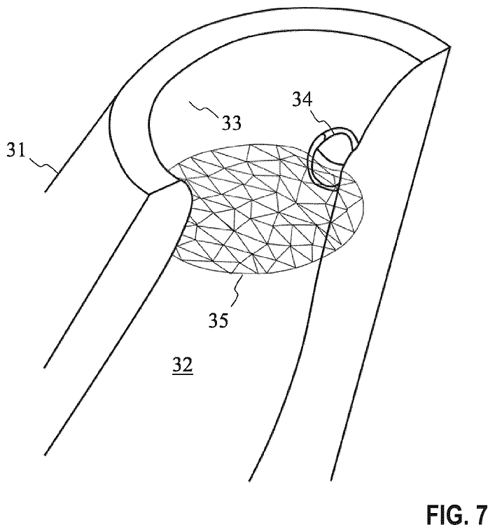

The object 31 depicted in FIG. 6 and FIG. 7 forms a channel 32 with a channel wall 33. The channel 32 is depicted cut open, in order to reveal its interior. The channel wall 33 contains a wall region 34 in which the channel wall 33 no longer has a continuously curved profile connecting to the adjacent regions. For example, a hole (for example a drilled hole), an indentation, a protrusion, an inlet or an outlet can be situated in the wall region 34. The case of an outlet can also be referred to as branching or branching off; the case of an inlet can also be referred to as an inflow. However, it is advantageous in all these cases to assume a profile of the channel wall 33 that has a continuously curved profile to the adjacent regions in the wall region 34 when executing the method according to an exemplary embodiment of the disclosure. In particular, discontinuities like in the wall region 34 could lead to unwanted solutions for the smallest cross-sectional area. For example, in the case of an indentation, the smallest cross-section area could be located at the indentation even though, in the case of an (assumed) continuously curved profile, the smallest cross-sectional area is located at a different location of the channel 32. In the case of a bulge, an inlet or an outlet, the smallest cross-sectional area could for example be found in a different section of the channel 32, even though the smallest cross-sectional area is located in the section with the hole, the indentation, the protrusion, the inlet or the outlet in the case of an (assumed) continuously curved profile.

The explanations given above with respect to a non-continuous profile of the channel wall do not only affect the exemplary embodiment shown in FIG. 6. When considering the flow or the flux, a non-continuous profile of the channel wall is often bothersome with regards to finding the smallest cross-sectional area, which is why a continuous profile is then assumed. If reference is previously made to a continuously curved profile of the channel wall, then this relates to the exemplary embodiment shown in FIG. 6 and to a large number of other cases. However, this does not preclude a channel wall from also being able to have plane regions (i.e., regions extending in a plane) or, more generally, able to have outlines (i.e., circumferential edge lines) which have at least one section with a straight extent. The hole, the indentation, the protrusion, the inlet or the outlet can be situated in this straight section. In this case, the assumption is advantageously made that the channel wall extends straight there (i.e., in a straight line), like in at least one adjacent wall region.

Further, an area of tessellation 35 formed exclusively of triangles is identifiable in FIG. 6 and FIG. 7; it was determined as an approximation of the smallest cross-sectional area of the channel 32 after the method according to the disclosure was executed. FIG. 6 also shows the first edge line 38, starting from which the area of tessellation 35 was determined by iterative determination of further areas of tessellation.

The example of FIG. 6 and FIG. 7 shows that a smallest cross-sectional area can also be determined as the area of tessellation if its edge is located in the region of an opening of the channel wall. For example, the channel wall at the opening can be augmented to form a closed channel wall. However, this is not required in many cases since the edge of a single tile can close the opening virtually. For example, the additional constraint that edge points of the area of tessellation must not be located in the opening can apply in that case.

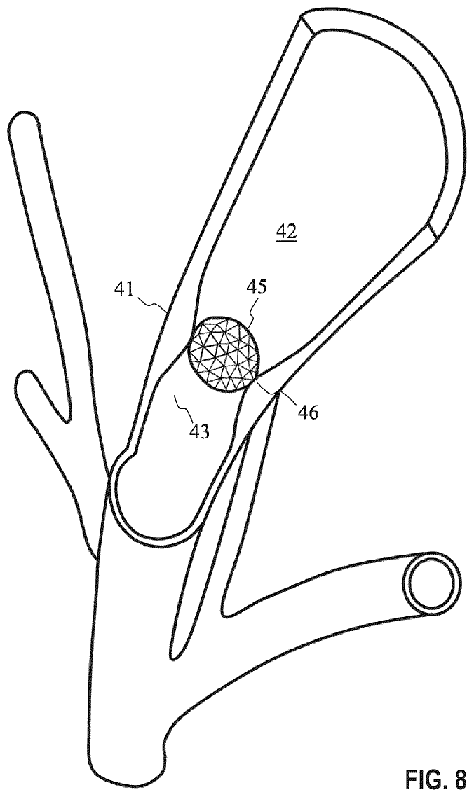

FIG. 8 shows a further example of an object with a channel 42, specifically a blood vessel 41 which is depicted partly cut open. A channel wall 43 is identifiable in a manner corresponding to the illustrations of FIG. 6 and FIG. 7. The smallest cross-sectional area is situated at a constriction 46 in the blood vessel, which was approximated as an area of tessellation 45 in the manner according to the disclosure.

### LIST OF REFERENCE NUMERALS

1 Coordinate measuring machine
2 Measurement table
3 Workpiece
5 Data processing device
11, 13 Blade
12, 14 Region of the hub of the blade wheel
16 Housing
18, 19 First edge line
20, 21 Area of tessellation
31 Object
32 Channel
33 Channel wall
34 Wall region
35 Area of tessellation of the smallest cross section
38 First edge line
41 Blood vessel
42 Channel
43 Channel wall
45 Area of tessellation of the smallest cross section
46 Constriction
P Corner point

What is claimed is:

1. A computer-implemented method for determining a geometric boundary for a mass flow, for an energy flow, or for a flow of force through a channel having a channel wall, the method comprising:
receiving or presenting coordinates of first edge points of a first edge line of a cross-sectional area of the channel, with the edge points being located on the channel wall;
receiving or creating, based on the first edge points, a first cross-sectional area as an area of tessellation with a gap-free and overlap-free arrangement of polygonal plane tiles of the area of tessellation, the first edge points being corner points of tiles of the area of tessellation, and the first edge points and all further, inner corner points of the tiles defining the first cross-sectional area;
determining further cross-sectional areas by iteration as areas of tessellation with the gap-free and overlap-free arrangement of the polygonal plane tiles;
varying a position of both edge points and inner corner points during the iteration;
terminating the iteration when a specified termination criterion is met; and
outputting information about a smallest cross-sectional area for which, with regards to the areas of tessellation from the iteration, an overall area of all tiles of a respective area of tessellation is minimized.

2. The method as claimed in claim 1, wherein edge points are displaced during the iteration, such that in each case the respective edge point continues to be located on the channel wall.

3. The method as claimed in claim 2, wherein new three-dimensional coordinates of a point on the channel wall are determined for edge points in each iterative step, by meeting a local condition that a sum of the areas of all tiles whose corner is defined by the respective edge point, and/or whose corners are defined by the corner points in a local region, is minimal while the three-dimensional coordinates of all other corner points remain unchanged.

4. The method as claimed in claim 1, wherein preliminary new three-dimensional coordinates of a point on the channel wall are determined for edge points in each iterative step, by meeting a local condition that a sum of the areas of all tiles whose corner is defined by the respective edge point, and/or whose corners are defined by the corner points in a local region, is minimal while the three-dimensional coordinates of all other corner points remain unchanged, and by meeting an additional displacement condition that the respective edge point can reach its preliminary new position defined by the preliminary three-dimensional coordinates only by way of displacement, from its previous position, in a tangential plane of the channel wall at the previous position, with this being followed by a displacement of the respective edge point from the preliminary new position to its, with regards to the iterative step, final new position on the channel wall should the preliminary new position not be located on the channel wall.

5. The method as claimed in claim 1, wherein new three-dimensional coordinates are determined for inner corner points in each iterative step, by meeting a local condition that a sum of the areas of all tiles whose corner is defined by the respective corner point, and/or whose corners are defined by the corner points in a local region, is minimal while the three-dimensional coordinates of all other corner points remain unchanged.

6. The method as claimed in claim 1, wherein the information output about the smallest cross-sectional area includes at least one of a size of the smallest cross-sectional area, at least one edge line of the smallest cross-sectional area, and three-dimensional coordinates of points of the smallest cross-sectional area.

7. The method as claimed in claim 1, wherein coordinates of the channel wall are measured by at least one coordinate measuring machine as input parameter for carrying out the computer-implemented method.

8. An apparatus for data processing, comprising:
a processor configured to execute the method as claimed in claim 1.

9. A computer program comprising instructions that, upon execution of the program by a computer, prompt said computer, or by a computer network, prompt said computer network to execute the method as claimed in claim 1.

10. A data carrier signal, which transmits the computer program as claimed in claim 9.

11. A non-transitory computer-readable medium comprising instructions that, upon execution by a computer, prompt said computer, or by a computer network, prompt said computer network to execute the method as claimed in claim 1.

12. An arrangement, comprising:
the apparatus as claimed in claim 8; and
a coordinate measuring machine configured to measure coordinates of the channel wall as input parameter for carrying out a computer-implemented method.
